(19) United States
(12) Patent Application Publication
(10) Pub. No.: US 2005/0051199 A1
(43) Pub. Date: Mar. 10, 2005

(54) Multi-use kitchen appliance

(76) Inventors: JoAnn Kay Drago, Jacksonville, OR (US); James Marshall Drago, Prospect, OR (US)

Correspondence Address: Jim Drago;c/o Prospect S District, PO Box 40, Prospect, OR, 97536, US

(21) Appl. No.: 10/657,113

(22) Filed: Sep. 9, 2003

(51) Int. Cl. B08B 3/02

(52) U.S. Cl. 134/56 D; 134/57 D; 134/58 D; 134/95.1; 134/95.2; 134/95.3; 134/99.1; 134/102.3

(57) ABSTRACT

A multi-use appliance that has the ability to wash and dry dishes, or produce, or can be used as a food dehydrator. The appliance uses various mixtures of hot and and cold water, at varying pressures, in different cycles to wash it's contents. The water temperature can be achieved either by receiving and mixing hot and cold water from a domestic source, or by just receiving cold water and heating the water by it's own water heater. It also can use different means to dry it's contents, through convection, or by use of a fan and it's own heating source. It can also incorporate means to disinfect it's contents. This can be done by injecting a disinfecting agent into the water supply or by an in-line o-zone generator. All this can be done by various preprogrammed cycles, that are either mechanically or computer controlled.

### CROSS-REFERENCE TO RELATED APPLICATION

This application claims the benefit of U.S. Provisional Application No. 60/408,051 filed Sep. 5, 2002, the entire disclosure of which is hereby incorporated by reference.

### BACKGROUND OF THE INVENTION

This invention relates to a multi-use kitchen appliance. More particularly, this invention relates to a kitchen appliance designed to automatically wash dishes, wash produce and dehydrate food. In the past typical dishwashers have had only a hot water input from a domestic source such as the hot water heater. They are single application appliances designed to wash dishes and other kitchen utensils in hot water, and then dry the contents automatically if desired. In the past few real improvements have been made to the appliance. The most notable have been the addition of varying cycles. Another improvement was the designing of different ways to configure the interior shelving which gave more room for the contents that were being washed. Yet another having the interior of the dishwasher pull out like a drawer to make it easier to load.

### SUMMARY OF THE INVENTION

It is the object of this invention to provide an appliance that is easy and safe to operate and is a multi-use appliance. The invention relates to a typical dishwasher. For the purpose of this invention many improvements are made. First of all a typical dishwasher for the most part has only one water input, it receives hot water through this input from a domestic source, usually the hot water heater, and it uses it to wash it's contents.

The first improvement this invention makes is to add a cold water input to the appliance. The easiest way to do this would be with the addition of an input similar to those used on clothes washing machines, a dual input water mixing valve. This would make both hot and cold water available to the appliance. This water mixing valve, along with it's controls, could be used to provide the appliance with water ranging in temperature from hot to cold, or to a temperature anywhere in between. If the mixing valve is not chosen as the way hot and cold water is made available, and it is chosen to let the unit heat it's own water, a heating unit would need to be added.

The next improvement would be the addition of controls, and a variable pressure pump. This would allow the appliance's dual temperature mixing valve to use different pressures of water at differing temperatures so that it could perform many different assignments, such as a cold gentle wash for produce, or a strong hot wash for dishes. The addition of adjustable or interchangeable jets would also allow the appliance to offer a gentle wash or a strong jet of water to be used. These controls could also call for a heat only timed dry cycle for dehydrating food.

For the purpose of this appliance the availability of cold water is added, allowing the appliance to use hot and/or cold water, or any mixture thereof. This is accomplished in a manner similar to the inputs and mixing valve on a typical clothes washer which has both cold and hot water inputs fed from the main house supply and the hot water heater respectively. The appliance could also have just one water supply, and means to heat or cool it's water supply according to the requirements of the chosen cycle by it's own internal heating or cooling unit.

The appliance incorporates different and various ways to disperse water dependent on the needs of the chosen cycle. For example a gentle wash for produce, and a stronger jet like flow for dishes, or any combination.

Appliance also incorporates different and various ways to dispense cleaning agents and/or disinfectants dependent on the requirements of the chosen cycle. They could be added manually or automatically. An inline ozone generator can also be incorporated to clean and/or disinfect contents.

The appliance also incorporates different and various ways to dry it's contents. For example as with a typical dishwasher an element that heats up to dry dishes. For the purpose of drying produce possibilities could include a unit that spins it, and/or a fan that blows air at various temperatures over the produce.

The appliance can also be used as a dehydrator if a dry only cycle is chosen.

The appliance also includes various switches, valves, and timers to control the needs of it's various cycles.

The appliance has holding units such as, shelves, baskets, trays, racks, and bags, that are configurable in a number of ways to fulfill the requirements of the chosen cycle, whether dishwashing or produce washing or dehydrating.

### BRIEF DESCRIPTION OF DRAWINGS

FIG. 1 is a schematic diagram of the multi-use kitchen appliance of the present and

FIG. 2 is a schematic diagram of an alternative embodiment of the multi-use kitchen appliance of the present invention.

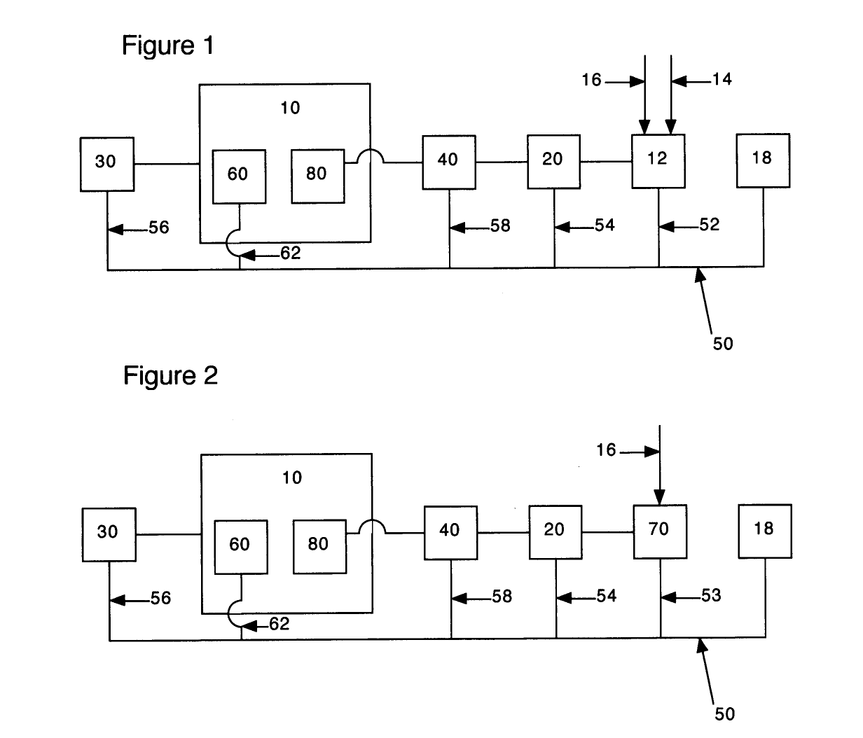

### DESCRIPTION OF PREFERRED EMBODIMENTS

In the drawings, the reference numbers refer to the following elements of the invention:
10 Article holding unit
12 Dual input water mixing valve
14 Hot waterline
16 Cold water line
18 CPU or electromechanical controller
20 Variable pressure pump
30 Air heating source and fan unit
40 Ozone generator
50 Electric line from CPU or controller
52 Electric line from line 50 to dual input mixing valve 12
53 Electric line from line 50 to water heater unit 70 (FIG. 2)
54 Electric line from line 50 to variable pressure pump 20
56 Electric line from line 50 to air heating source 30
58 Electric line from line 50 to ozone generator 40
60 Disinfectant injector unit
62 Electric line from line 50 to disinfectant injector 60
70 A water heater unit (FIG. 2)
80 Water distribution unit

To use the appliance as a dishwasher it is used in a typical manner. What is different is that the appliance has any number of master cycles, i.e. one to wash dishes and one to wash produce and one to dehydrate, all controlled by #18.

For washing dishes the dishwashing cycle is chosen. The article holding unit 10 is loaded with dishes. It's shelves and racks are designed to offer a variety of options. A cleaning agent/disinfectant method is chosen, and/or added, #40 or #60 respectively, as desired. A sub cycle is chosen, short wash or pots and pans etc. #18. The drying cycle is chosen, or not, dependent on the users desire, for example—heated element drying with air #30, and the appliance is started. This is representative to some degree of a typical dishwasher.

To use the appliance as a produce washer, the produce washing cycle is chosen from the master menu #18. The article holding unit #10 is configured to the users needs. The appliance is loaded with produce. A cleaning agent/disinfectant method is chosen #40 or #60 respectively, as desired. A sub cycle is chosen, for example—gentle 5 minute wash # 18. The drying cycle is chosen or not dependent on the users desire, for example—forced cool air dry #30, and the appliance is started.

To use the appliance as a dehydrator, the dehydrator cycle is chosen #18, the article holding unit #10 is configured to the users needs. The appliance is loaded. A sub cycle is chosen, for example—warm air at 150 degrees #18, and the appliance is started.

With hot and cold water #'s 12 & 70, various ways of dispersing the water # 80, various ways of dispensing cleaning/disinfecting agents #'s 40 & 60, various ways of drying # 30, and a control unit offering many and varied cycles # 18, the appliance could offer a wide range of temperatures, water pressure, length of cycles, and drying possibilities, in the sub cycles, of any of the master cycles, dependent on the design of the appliance, master cycles, and sub cycles.

1. A multi-use kitchen appliance comprising:
an article holding unit having a top, bottom, rear wall, side walls, and a front wall that opens to allow access to the inside of the unit, and shelves and racks and other article retaining means located within the interior of said unit;
a water line communicating the interior of said unit with a source of water, and valve means to turn on and off communication with said source of water; and
an air heater means for heating the ambient air and a means to circulate it in the interior of the said unit.

2. The appliance of claim 1 including a water line communicating the interior of said unit with a source of hot water, a water line communicating the interior of said unit with a source of cold water, and mixing valve means to turn on and off communication with said hot and cold water lines in a manner adapted to achieve a desired temperature.

3. The appliance of claim 1 including a disinfectant injector means to interior of unit.

4. The appliance of claim 1 including an in-line ozone generator on the water line which communicates water to the inside of said unit.

5. The appliance of claim 1 including a water heater for heating said water prior to its entry into said unit.

6. The appliance of claim 1 including a water pressure pump to control pressure that water is delivered to inside of said unit.

7. The appliance of claim 1 including a means of distributing water over articles inside of said unit.

8. The appliance of claim 1 including a CPU for controlling said valve means and said air heater means and said pressure means and said water temperature means.
